(19) United States
(12) Patent Application Publication
(10) Pub. No.: US 2016/0260047 A1
(43) Pub. Date: Sep. 8, 2016

(54) MONITORING INDIVIDUAL AND AGGREGATE PROGRESS OF MULTIPLE TEAM MEMBERS

(71) Applicant: BetterWorks Systems, Inc., Redwood City, CA (US)

(72) Inventors: Kris Duggan, Palto Alto, CA (US); Ciara Peter, San Francisco, CA (US); Bradley Yoo, Palo Alto, CA (US); Vincent Huang, San Mateo, CA (US); Randall Hom, San Francisco, CA (US)

(21) Appl. No.: 15/059,120

(22) Filed: Mar. 2, 2016

Related U.S. Application Data
(60) Provisional application No. 62/127,742, filed on Mar. 3, 2015.

(51) Int. Cl. G06Q 10/06

(52) U.S. Cl. CPC G06Q 10/063114

(57) ABSTRACT

Systems and methods are described to intelligently determine adjusted real time probabilities that various task assignments will be completed by corresponding deadlines and, therefore, whether an overall team objective that the various tasks are designed, in the aggregate, to achieve. Determinations may be based in part on recent computing activity associated with data files of individual tasks. In particular, data files that correspond to individual tasks may be flagged as such by a service provider that may then track computer based activity such as increased data size of files or increased frequency of save event. By tracking which do not have a predetermined level of computing activity with regard to associated data files these tasks may be identified and resolved.

### CROSS-REFERENCE TO RELATED APPLICATIONS

The present application claims the benefit of U.S. Provisional Patent Application No. 62/127,742 filed Mar. 3, 2015, which is incorporated herein by reference in its entirety as if fully set forth herein.

### BACKGROUND

A number of project management applications have developed in recent years that are designed to facilitate recordation of task assignments and collaboration between team members. In some cases, task assignments for team members are entered into a task list in which team members can manually enter an estimated progress for individual tasks on the task list. Typically, any particular team member is unable to access different team members' task lists to review their progress. For example, while a manager of two team members may be able to view each team members' respective task list, each team member may be unable to see the other team member's task list and associated progress. Furthermore, each respective task list is typically independent of the other respective task list. For example, each task list fails to recognize any interdependencies between various tasks on the particular team member's task list and the various tasks of another team member's task list.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a pictorial flow diagram that shows an illustrative process of intelligently determining real time probabilities of timely completion of a plurality of tasks that correspond to a team objective in accordance with certain embodiments of the disclosure.

FIG. 2 is a block diagram of a process of determining probabilities of timely completion of a plurality of tasks that correspond to a team objective in accordance with certain embodiments of the disclosure.

FIG. 3 illustrates an overview of a user interface application that is accessible via a web portal to access and/or upload information to or from a service provider, in accordance with various implementations of the disclosure.

FIG. 4 illustrates an overview of an exemplary environment for implementing systems and methods disclosed herein.

### DETAILED DESCRIPTION

This disclosure provides systems and methods for determining a probability that one or more tasks that correspond to a team objective will be completed in a timely manner. Embodiments of the disclosure intelligently identify and elevate tasks that have a low probability of being completed by a project deadline. In some embodiments, a reported actual progress for a task is compared to an expected progress for the task to determine a probability of task being completed on time. The actual progress for the task may be based on one or more progress updates received from a task owner, e.g. a team member to whom the task is assigned. The expected progress for the task may be based on a comparison between an amount of time having elapsed since a commencement date for the task and a total amount of time between the commencement date and a deadline for the task. In some embodiments, the expected progress is measured linearly. For example, in a particular situation in which there are a total of twenty working days between the commencement date and the deadline, the expected progress will increase by 5% for each working day. In some embodiments, working days may exclude weekends and/or holidays.

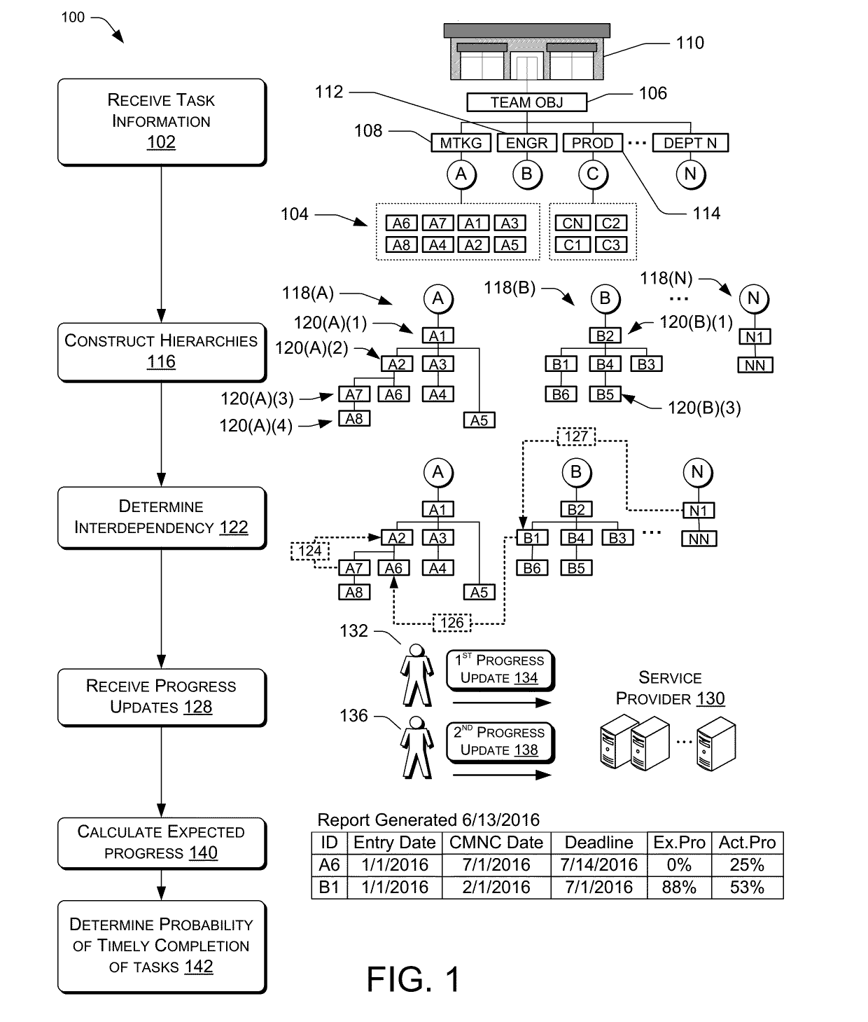

FIG. 1 is a pictorial flow diagram that shows an illustrative process of determining probabilities of timely completion of numerous tasks that correspond to a team objective. The order of the blocks below is not limiting, and thus the operations associated with the blocks below may be performed in a different order and/or some operations may be performed in parallel with other operations.

At block 102, information may be received that is associated with a plurality of tasks 104 that correspond to a team objective 106. The team objective 106 may be an objective of a single team within a single functional department, e.g. a team objective of a marketing department 108 of a business 110. In some embodiments, the team objective 106 may be a top-level objective of the business 110 which spans across, and requires collaboration of, multiple functional departments, e.g. the marketing department 108 and an engineering department 112. In some embodiments, the plurality of tasks 104 may be grouped according to a corresponding functional department that individual ones of the tasks may be assigned to. For example, in the pictorial flow diagram of FIG. 1, tasks A1-A8 correspond to the marketing department 108 and tasks C1-CN correspond to a production department 114.

In some embodiments, the information may include a plurality of task owners, e.g. one or more team member assignments of individual ones of the plurality of tasks. In some embodiments, individual team members may be assigned to individual tasks. For example, there may be only a single team member assigned to complete any one task. In some embodiments, some tasks may have more than one assigned team member. For example, three team members may be assigned to a particular task. In some embodiments, the information may also include a plurality of deadlines that correspond to the plurality of tasks. For example, each particular task may have a corresponding deadline or just some of the task may have a corresponding deadline.

In some embodiments, the information may include one or more activity commencement dates for at least some of the plurality of tasks. For example, the activity commencement date may define a date at which activity associated with a particular task is expected to begin. It should be appreciated that an activity commencement date for any particular task may be set for a date that is subsequent to a date at which the information associated with the event is received. Stated alternatively, information associated with at least some of the tasks may be received at block 102 before any activity associated with the tasks is expected to be performed. For example, the receiving the information at block 102 may occur during a planning phase prior to any work being performed toward the team objective.

At block 116, one or more hierarchies 118 may be constructed that correspond to the plurality of tasks 104. In the illustrated embodiment, hierarchy 118(A) corresponds to the plurality of tasks A1-A8 and hierarchy 118(B) corresponds to the plurality of tasks B1-B6. The hierarchies 118 may define a plurality of priority levels 120 that are each indicative of a degree of relevance with respect to the team objective 106. For example, priority level 120(A)(1) denotes a first degree of relevance to the team objective 106 for tasks assigned to the marketing department 108 while priority level 120(B)(3) denotes a third degree of relevance to the team objective 106 for tasks assigned to the engineering department 112. It should be appreciated that degrees of relevance with respect to the team objective 106 do not necessarily translate across departments such that the highest priority tasks for one department have substantially the same importance/relevance as the highest priority tasks for another department. For example, suppose the team objective 106 is to achieve 25% market share for a soon to be released product. In this case, a highest priority task of the engineering department of designing the product may be more relevant to the team objective 106 than the highest priority task of the marketing department of generating a television commercial for the product. For example, without engineering's objective of designing the product there will be nothing to sell to gain the market share no matter how persuasive the commercial generated by marketing.

In some embodiments, the one or more hierarchies 118 are configured to define contributing relationships between tasks. For example, in hierarchy 118(A) each of tasks A2, A3, and A5 contribute toward completion of task A1. In some embodiments, whether a particular task contributes toward another task is an independent inquiry from the priority level of that particular task. For example, FIG. 1 illustrates that A5 is directly contributes toward task A1, e.g. there is no intervening contributing task, and is a fourth level priority task, e.g. it appears on priority level 120(B)(4). Accordingly, tasks A4, A6, and A7 may be considered to be more relevant to the completion of team objective 106 than task A5 even though these tasks indirectly contribute to task A1, e.g. task A3 is an intervening task between tasks A4 and A1. It should also be appreciated that task A1, B2, and N1, each contribute toward completion of team objective 106.

At block 122, one or more interdependencies (124, 126, and 127) between tasks may be determined. An exemplary interdependency may indicate that performing at least a portion of one task may be dependent on completion of at least a portion of a different task. For example, interdependency 124 indicates that at least a portion of task A2 is at least partially dependent on completion of at least a portion of task A7. In some instances, the interdependency 124 may be an absolute dependency such that task A2 cannot possibly be completed until the relevant portion of task A7 is completed. For example, suppose task A7 is to select consumers to participate in a focus group and that task A2 is to conduct the focus group. Based on this example, it should be appreciated that the focus group cannot be conducted at task A7 until the corresponding consumers are selected at task A2.

In some embodiments, one or more interdependencies may transcend functional departments such that a task of one department is at least partially dependent on a task of another department. For example, interdependency 126 transcends the marketing and engineering functional departments in that completion of at least a portion of task A6 which is assigned to the marketing department 108 depends, at least partially, on completion of at least a portion of task B1 which is assigned to the engineering department 112. To elaborate, suppose task A6 is to supply a group of consumers whom have agreed to perform a beta test product evaluation with a beta version of a product. Further, suppose that task B1 is to develop and supply the beta version of the product to marketing. Accordingly, task A6 is at least partially dependent on task B1 because marketing must obtain the beta product version from engineering in order to complete task A6; however, at least a portion of A6 is independent from task B1 since marketing can identify and communicate with the group of consumers before task B1 is completed.

At block 128, progress updates may be received regarding actual progress that has been achieved for one or more of the tasks. In some embodiments, each respective task owner is responsible for supplying the progress updates to a service provider 130. For example, a first task owner 132 that is assigned to perform a first task such as, for example, task B1 may provide a first progress update 134 to the service provider 130 to indicate an actual amount of progress that has been achieved for the task B1. A second task owner 136 may provide a second progress update 138 to the service provider 130 to indicate an actual amount of progress that has been achieved for the task A6. In some embodiments, progress updates for any particular task may only be provided by a corresponding task owner, e.g. if task B1 is assigned to task owner 132 then only task owner 132 is permitted to provide progress updates for task B1. In some embodiments, progress updates may only be provided to the service provider 130 by an intermediary between the service provider 130 and the respective task owners. For example, a project manager that is in charge of managing and reporting on progress toward the team objective 106 my receive progress updates from the task owners and vet or otherwise validate the updates prior to entering the updates at the service provider 130. In some embodiments, any user (e.g. whether or not that user is a task owner) is permitted to provide progress updates, e.g. task owner 132 may provide progress updates for a task assigned to task owner 136.

At block 140, expected progress may be calculated based on time information, such as a current time or date, or based on a future date (such as the next day at 8:00 AM in the morning). For example, with reference to the report illustrated in FIG. 1, suppose the current date is Jun. 13, 2016 and that tasks A6 and B1 have dates and progress per the illustrated report. In particular, that report indicates that the initial information corresponding to tasks A6 and B1 was received on Jan. 1, 2016 but also that no work was planned or expected to commence prior to Jul. 1, 2016 for task A6 or Feb. 1, 2016 for task B1. Accordingly, because Jun. 13, 2016 is prior to the planned activity commencement date of Jul. 1, 2016 for task A6, the expected progress may be calculated as 0% for task A6. Stated alternatively, no time has elapsed during which task owner 136 is expected to have been working on task A6. However, on Jun. 13, 2016, 133 days have elapsed out of a total of 151 days between commencement date Feb. 1, 2016 and deadline Jul. 1, 2016 that corresponds to task B1. Accordingly, based on an expectation of linear progress and no weekend and/or holiday exceptions, the expected progress for task B1 may be 88%. In some embodiments, the expected progress is non-linear and/or may include weekend and/or holiday exceptions. For example, it may be expected or planned that a majority of work for task B1 (or any task for that matter) will be completed as the deadline approaches. Accordingly, the expected progress may progress by 0.5% for the first 100 days and then roughly 1% per day for the remaining 51 days. It should be appreciated that other progress schedules are contemplated for use with the systems and methods disclosed herein. In some embodiments, the expected task progression may be calculated based on current week, month, every other week, or based on some other time frame versus daily. For example, a certain amount of progress may be expected each week, even if the progress is spread out unevenly through the week. Other examples are possible without departing from the scope of embodiments.

At block 142, a determination may be made of a probability that any particular task will be timely completed. In some embodiments, the determination is based on a difference between the expected progress for any particular task and the actual progress reported at block 128. For example, with particular reference to the Report Generated Jun. 13, 2016, because the expected progress for task A6 is 0% and task owner 136 is ahead of schedule having reported an actual progress of 25%, it may be determined that there is high probability, e.g., 95%, that task A6 will be completed by the deadline of Jul. 14, 2016.

In some embodiments, the determination for one task is further based a probability that a different task will be completed by its corresponding deadline. For example, at block 122 it was determined that performance of task A6 is at least partially dependent on task B1 being performed and, therefore, the determination of block 142 as it relates to task A6 may be further based on information associated with task B1. For example, suppose that as of Jun. 13, 2016 task B1 is reported as only being 53% complete and that as a result there is a low probability that task B1 will be completed by its deadline of Jul. 1, 2016 or even the deadline of task A6, i.e. Jul. 14, 2016. Accordingly, when weighing information for task B1 when determining the probability of timely completion of task A1 the probably may no longer be a high 95% but rather may be calculated to have a lower chance of timely completion. If a particular task is entirely dependent on a different task, then the particular task's probability of timely completion will generally be less than or equal the probability of the other task. For example, if the task A6 cannot be performed unless task B1 is timely performed and there is only a 33% chance that task B1 will be timely completed then the probability of timely completion of task A6 will be less than or equal to 33%.

In some embodiments, the determining the probability of timely completion of tasks at block 142 is further based on historical performance data associated with one or more task owners and/or groups of task owners. For example, with particular reference to the report generated Jun. 13, 2016 of FIG. 1, suppose that task owner 136 is assigned to complete task A6 and that task owner 132 is assigned to compete task B1. Based on the data displayed within the report, it may be determined that task owner 132 is less likely to complete task B1 by the corresponding Jul. 1, 2016 deadline than for task owner 136 to complete task A6 by Jul. 14, 2016. However, historical performance data associated with task owner 132 may indicate that she has never missed a deadline in her long career at the business 110. This historical performance data may further indicate that she typically finishes projects with a large surge of activity toward the end of the project or that she is not diligent about entering progress updates at block 128. Accordingly, it may be determined that despite task B1 being seemingly behind schedule that there is still a high probability that task owner 132 will complete task B1 by the deadline. It should be appreciated that historical performance data may lead to a contrary result as well. For example, if historical performance data indicates that task owner 136 rarely finishes projects on time despite typically getting off to a strong start then the probability of task A6 being completed by the deadline of July 14, may be adjusted accordingly. In this way, project management personnel may be provided with analytical insights into probable current and/or future performance based on concrete data that corresponds to past performance of particular individuals and/or the team as a whole.

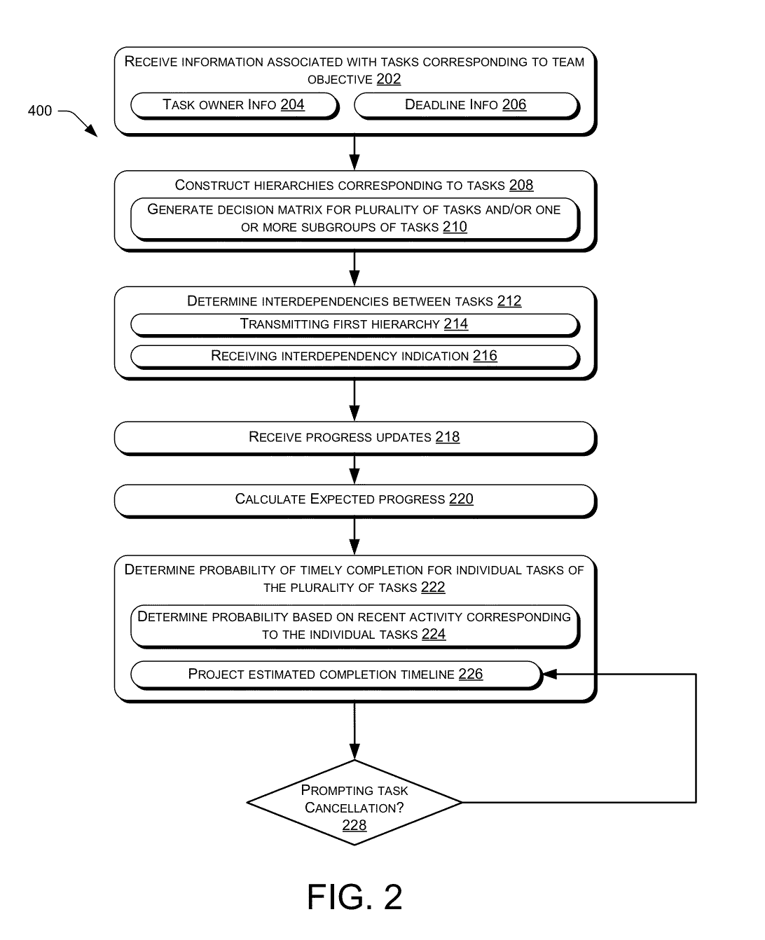

FIG. 2 is a block diagram of a process of determining a probability of timely completion of a plurality of tasks that correspond to a team objective in accordance with certain embodiments.

At block 202, information associated with a plurality of tasks that correspond to a team objective may be received. In some embodiments, the information is received by a service provider such as, for example, service provider 130. The service provider 130 may provide services corresponding to the systems and methods disclosed herein via a web based application. For example, the systems and methods disclosed herein may be provided through a web portal, e.g. users may access the systems through a web browser. In some embodiments, the information is received by one or more computing systems of the business 110. For example, the systems and methods disclosed herein may be performed by one or more servers, e.g. servers that are maintained by the business 110, or on one or more personal computing devices.

In some embodiments, the information may include task owner information 204. The task owner information 204 may be received simultaneously with and/or after the task information is received at block 202. For example, it should be appreciated that in some embodiments the plurality of tasks may be defined prior to any actual assignment of the tasks to task owners. This may be beneficial in organizational depth planning, e.g. the managers and/or existing team members may attempt to define the scope of the plurality of tasks and estimated work hours needed to complete those tasks prior to hiring additional personnel and/or distributing the task assignments between team members. Furthermore, in some embodiments, deadline information 206 that defines deadlines for individual ones of the plurality of tasks may also be received at block 202. It should be appreciated that similar to the task owner information 204, the deadline information 206 may be received subsequent to the tasks information being initially received at block 202.

At block 208, one or more hierarchies may be constructed that correspond to the task information received at block 202. In some embodiments, one or more users is prompted to arrange the plurality of tasks into a plurality of priority levels. For example, a user(s) may be prompted to define how relevant each task is with relation to each other task within the plurality of tasks. In some embodiments, construction of the hierarchies at block 208 includes generating one or more decision trees at block 210. Such decision trees may be generated for the entire plurality of tasks, e.g. each task of the plurality of tasks may be compared (in terms of importance towards achieving the team objective 106) to each other task within the plurality of tasks. In some embodiments, the plurality of tasks is arranged into subgroups of tasks that correspond to different functional departments and/or different portions of an organizational hierarchy and then individual hierarchies may be generated for the different subgroups. For example, referring back now to FIG. 1, tasks A1-A8 may be a subgroup of tasks that correspond to a team objective 106 and that also correspond to and/or are assigned within the marketing department 108. Similarly, tasks B1-B5 may be a subgroup of tasks that correspond to and/or are assigned to the engineering department 112. Accordingly, while all of tasks A1-A8 and B1-B5 may be considered to be within the plurality of tasks, these tasks may be split into subgroups before the hierarchies are formed such that not all tasks of the plurality of tasks exist share a hierarchal relationship.

At block 212, one or more interdependencies between tasks may be determined such as, for example, interdependency 124 between task A7 and A2 and/or interdependency 126 between task B1 and task A6. It should be appreciated that interdependencies may include direct dependencies and/or indirect dependencies. For example, a direct dependency may be represented each of dependencies 124 and 126 in that tasks A2 and A6 depend from tasks A7 and B1 respectively. However, suppose that B1 is also dependent on task N1. In this case, tasks A6, B1, and N1 are interdependent with respect to one another in the sense that task A6 is directly dependent on task B1 and indirectly dependent on task N1.

In some embodiments, determining the interdependencies at block 212 includes transmitting at least some information corresponding to a first subgroup of tasks to one or more individuals associated with a different subgroup of tasks. For example, once a hierarchy is constructed at block 208 it may be transmitted to a task owner that is associated with a difference subgroup and/or hierarchy of tasks. For example, once the hierarchy 120(B) is constructed at block 116 or 208 it may be transmitted to task owner 136 for review. Task owner 136 may then review hierarchy 120(B) and determine that task A6 is dependent on task B1, e.g. the beta products cannot be delivered to consumers until engineering provides the beta version samples. In some embodiments, it may be determined that a particular task is missing from the hierarchy. For example, at a time when the hierarchy 120(B) is transmitted at block 214 a particular task may be omitted from the hierarchy. Upon reviewing the hierarchy, the absence of the particular task may be identified. For example, suppose task A6 is assigned to task owner 136 and that hierarchy 120(B) is transmitted to task owner 136 for review. It should be appreciated that task owner 136 may identify that a task that must be performed in order for task A6 to be performed is missing.

At block 216, an interdependency indication may be received. For example, task owner 136 may transmit an indication of the dependency to the service provider 130. In some embodiments, the task owner 136 may be provided with a fillable form into which a description of the dependency and/or missing task may be provided. For example, the task owner may assert that task A6 of providing beta products to consumers cannot be completed by marketing until engineering provides designs and provides the product to marketing at task B1.

At block 218, which is similar to block 128, progress updates may be received by the service provider which indicate an amount of actual progress that has been achieved for individual tasks.

At block 220, which is similar to block 140, an expected progress may be calculated for individual ones of the tasks. In some embodiments, the expected progress is calculated for each individual task based upon an amount of time having elapsed since an expected activity commencing time/date. In some embodiments, an aggregate expected progress is calculated for the entire project. For example, an average of each of the individually calculated expected progresses is calculated. In some embodiments, such an average is a weighted average. For example, suppose there are only three tasks and that the first task is expected to take 10 days, the second task is expected to take 30 days, and the third task is expected to take 30 days. Further suppose that the first task is 100% complete and the second task is 50% complete and the third task is 0% complete. In such an instance, the weighted average may be calculated to be 36% (as opposed to the unweighted average of 50%).

At block 222, one or more determinations may be made as to the probability that any particular one of the plurality of tasks will be completed on time. For example, if a particular task is being completed ahead of schedule, e.g. the expected progress is lower than the actual progress, and the particular task is independent of other tasks then it may be determined that there is a high probability that the particular task will be completed on time. In contrast, if the particular task is behind schedule and widely dependent on numerous other tasks that are also behind schedule then there may be a very low probability that the task will be completed by its deadline. It should be appreciated that an object of the present disclosure it to expose weaknesses in resource allocation such as over assigning resources, e.g. employees, to particular high visibility tasks without assigning adequate resources to less visible tasks (e.g. tasks which management is less focused on or aware of) that other tasks are dependent on.

In some embodiments, determining the probability that individual tasks will be timely completed is at least partially dependent on recent activity that has occurred. For example, suppose that a report is generated three days before a task deadline and that the corresponding task is 95% complete even though it is only expected to be 80% complete by this time. Further suppose that the owner of this task has been steadily entering progress for several different tasks which are slightly behind schedule and which are also due in three days but has not entered any new progress on the task of interest in several months. Accordingly, the lack of recent activity corresponding to the task of interest may indicate that the task owner has forgotten about the task or simply does not have the time to perform the task. Under such circumstances, the lack of recent activity may factor into and lower the probability that the task will be timely completed. In some embodiments, the recent activity may be a type of activity such as viewing materials corresponding to the task. For example, it may be more likely that a particular task will be completed on time if the task owner has viewed or updated materials that are flagged (e.g. via a metadata tag) as corresponding to the particular task than if the task owner has never viewed or updated any such materials, e.g. the lack of activity may be at least partially indicative that the task owner is either unaware of or not focused on the task.

In some embodiments, information related to recent activity corresponding to any particular task may include an increase in a data storage footprint corresponding to the task. For example, an individual task may have a corresponding folder that associated data files are to be stored in and/or one or more data files may be flagged as corresponding to the particular task. Accordingly, the systems and methods disclosed herein may include monitoring activity related to these data files and note that the size of the files have recently been steadily increasing which is indicative that a task owner is aware of and has been working on the particular task. In some embodiments, the information related to recent activity may include a frequency of data file save events corresponding to the particular task. For example, a higher frequency of save events may be assumed to correlate to a higher probability that the task will be completed by a corresponding deadline.

At block 226, an estimated completion timeline may be estimated for one or more individual tasks and/or one or more hierarchies of subgroups of tasks and/or the entire project. In some embodiments, estimated completion timelines may be estimated based on certain assumptions related to historical performance. For example, historical progress may be estimated to linearly continue such that if 50% of the task has been completed over the last 100 days then another 100 days into the future may be estimated as the projected completion date. In some embodiments, recent historical performance is weighted more heavily very old or stale historical performance. For example, suppose still that 50% of the task has been completed over the last 100 days but further suppose that 25% has been completed in the last 24 hours. In some embodiments, the more recent historical performance may be weighted more heavily such an estimated completion date is roughly two days into the future.

In some implementations, at block a user may be prompted to select one or more tasks for cancellation based on the projected timeline extending beyond a team objective deadline, e.g. a main deadline for the team objective 106. For example, the system may provide a display of the lowest priority tasks and/or the tasks with lower levels of interdependency. Furthermore, in some implementations, the estimated completion timeline may be iteratively re-projected following the cancellation of the tasks at block 226.

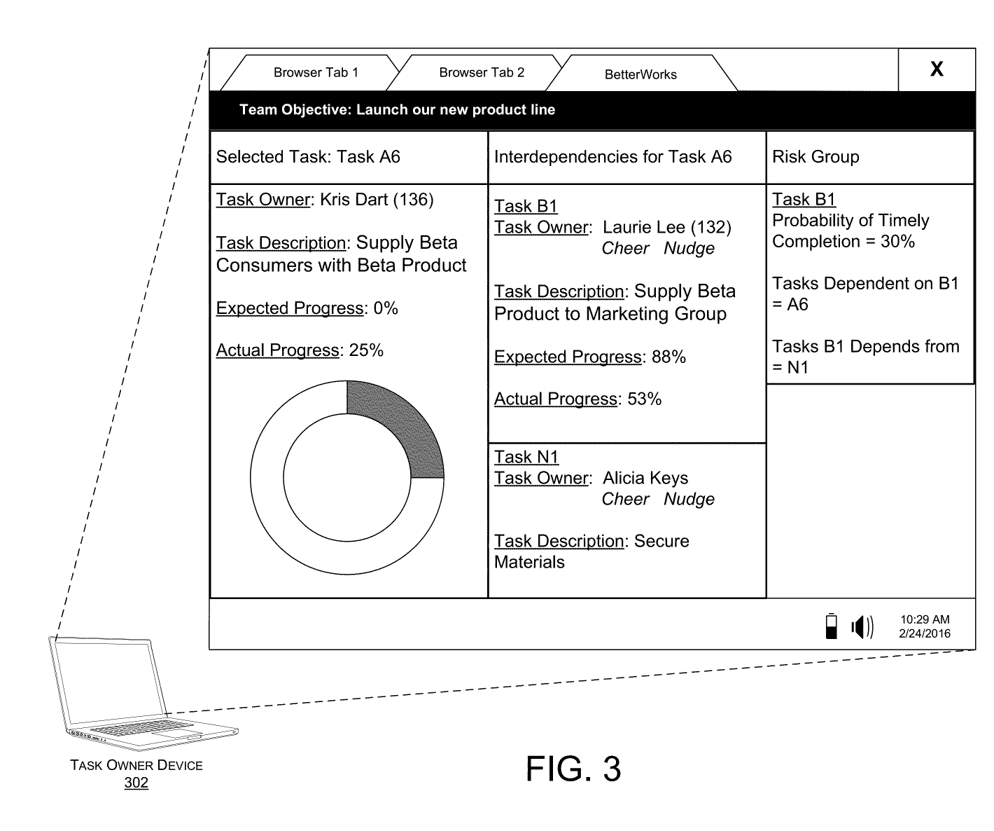

FIG. 3 illustrates an overview of a user interface application that is accessible via a browser application to access and/or upload information to or from a service provider, in accordance with various implementations of the disclosure. It should be appreciated that although a laptop style PC computer is illustrated in FIG. 3, and suitable device may be used as the task owner device 302. It is within the scope of the present disclosure for the task owner to access the user interface application via a desktop computer, a smartphone, a tablet computing device, etc.

In some implementations, one or more probabilities of timely completion may be determined for the individual tasks (as described elsewhere herein) and, one or more tasks which have a probability of timely completion that is below a certain threshold may be elevated to a risk group that is displayed via a web portal application. In some embodiments, a risk group may correspond to a team objective such that any task that is at risk of untimely completion may be elevated to the risk group. Furthermore, in some embodiments, risks groups may also be specific to one or more particular tasks such as, for example, a subgroup of tasks within a hierarchy or a single task. In the illustrated embodiments, the displayed risk group is specific to task A6. In some embodiments, the information corresponding to the selected task, e.g. task A6, may include one or more of a task description, a probability of timely completion, and an adjusted independent probability of timely completion. For example, although task A6 may have a very low probability of timely completion of 25% this may be largely due to its dependency on task B1 which itself has a low probability of timely completion, i.e. 30%. Accordingly, task A6 did not depend from task B1 its probability of timely completion would likely be much higher. Stated alternatively, if completion of task A6 were independent such that task owner 136 was the only individual whom could control whether task A6 is completed on time then an adjusted probability may be estimated at 90%.

It is an object of the present disclosure to further provide insights into a task owner's true worth to the business through correlations which are otherwise opaque. In particular, suppose task owner 136 was assigned a variety of tasks which were highly dependent on other tasks which are assigned to less reliable personnel which constantly miss deadlines during the course of the project. Accordingly, based on unadjusted statistics, which indicate that task owner 136 delivers timely work products only 50% of the time, it may appear to management personnel that task owner 136 is himself unreliable. Furthermore, because many people are uncomfortable speaking poorly of others, task owner 136 may refrain from fully explaining the cause of his seemingly poor performance. However, it should be appreciated that the adjusted probability of timely completion, i.e. w/o interdependence, being provided to management enables management to both recognize the true value of task owner 136 to the business 110 and also to increase his workload if need be.

In some embodiments, the user interface application provides a means of directly contacting, e.g. via a messaging portal, other task owners to provide social encouragement and/or reminders regarding various tasks. For example, in the illustrated scenario, task owner 136 Kris Dart may realize from his dashboard that he will be unable to meet his own deadline for task A6 unless task owner 132 Laurie Lee reverses course and improves her own performance. Furthermore, if task owner 136 is able to assist he may offer assistance via the messaging portal. In particular, task owner 136 may select one of the “cheer” or “nudge” radio buttons to provide the social encouragement and/or reminder to task owner 132. Accordingly, it is another object of the present disclosure to facilitate a high collaboration among various task owners that are all working toward a common team objective.

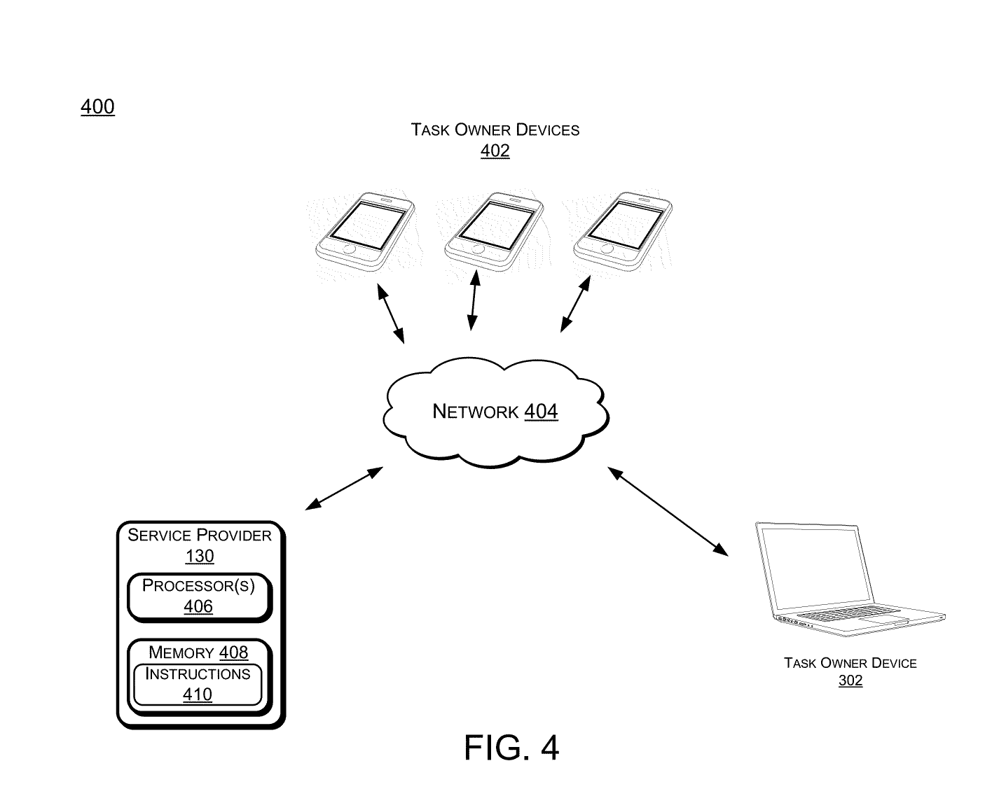

FIG. 4 illustrates an overview of an exemplary environment for implementing systems and methods disclosed herein. In some embodiments, the service provider 130 may include, but is not limited to, one or more processor(s) 406 each of which may include at least a central processing unit (CPU) having numerous arithmetic logic units (ALUs) that perform arithmetic and logical operations, as well as one or more control units (CUs) that extract instructions 410, that may be stored on one or more memories 408, and stored content from processor cache memory, and then executes these instructions 410 by calling on the ALUs, as necessary, during program execution. In some embodiments, a plurality of task owner devices 402 and 302 may communicated with the service provider 130 via one or more network(s) 404.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computer-implemented method, comprising:
receiving information associated with a plurality of tasks corresponding to an objective, the information including at least a plurality of task owners and a plurality of deadlines;
constructing at least one hierarchy corresponding to the plurality of tasks, the at least one hierarchy defining a plurality priority levels that are each indicative of a degree of relevance with respect to the objective, wherein individual ones of the plurality of tasks are assigned to individual ones of the plurality of priority levels;
determining an interdependency between at least a first task of the plurality of tasks and a second task of the plurality of tasks, the interdependency indicating that performing at least a portion of the second task is dependent on completion of at least a portion of the first task;
receiving at least a first progress update and a second progress update, the first progress update indicating a first actual progress achieved corresponding to the first task and the second progress update indicating a second actual progress achieved corresponding to the second task;
calculating at least a first expected progress corresponding to the first task and a second expected progress corresponding to the second task;
determining a probability of timely completion of the second task, the determining based at least partially on:
a difference between the first expected progress and the first actual progress,
a difference between the second expected progress and the second actual progress.

2. The method as recited in claim 1, further comprising determining, for the second task, recent activity having occurred within a predetermined time period, the recent activity including at least one of: an amount of the recent activity; or a type of the recent activity.

3. The method as recited in claim 2, wherein the recent activity includes at least one of: an increase in a data storage footprint corresponded to the second task; or a frequency of data file save events corresponding to the second task.

4. The method as recited in claim 1, wherein the information associated with the plurality of tasks indicates, for the second task, an activity commencement date and a deadline, the activity commencement date being subsequent to the receiving the information.

5. The method as recited in claim 4, wherein the second expected progress is based at least partially on a current date, the activity commencement date, and the deadline.

6. The method as recited in claim 1, wherein the at least one hierarchy includes a first hierarchy that corresponds to a first functional department and a second hierarchy that corresponds to a second functional department, the first hierarchy including a first subset of the plurality of tasks that contribute to the objective and the second hierarchy including a second subset of the plurality of tasks that contribute to the objective.

7. The method as recited in claim 6, wherein the determining the interdependency between the first task and the second task includes:
transmitting at least one of the first plurality of tasks or the first hierarchy to a second task owner, of the plurality of task owners, that is assigned to perform the second task;
receiving, from the second task owner, an indication of the interdependency between the first task and the second task.

8. The method as recited in claim 7, wherein the first task is omitted from at least one of the first hierarchy or the first plurality of tasks at a time of the transmitting, and wherein the receiving the indication of the interdependency includes receiving, from the second task owner, a description of the first task.

9. The method as recited in claim 6, further comprising:
transmitting an alert to a second task owner, of the plurality of task owners, that is assigned to perform the second task, wherein the alert provides an indication of the first actual progress and a radio button to enable the second task owner to transmit a message to a first task owner that is assigned to perform the first task.

10. The method as recited in claim 1, further comprising:
projecting an estimated timeline for completion of the objective based at least partially on historical progress data corresponding to the plurality of tasks, the estimated timeline including at least an estimated completion date; and
in response to the estimated completion date being subsequent to a objective deadline, prompting at least one of the plurality of task owners to select one or more of the plurality of tasks for cancellation.

11. The method of claim 10, wherein the prompting includes identifying at least two uncompleted tasks, of the plurality of tasks, and wherein the prompting further includes ranking the at least two uncompleted tasks according to the at least one hierarchy.

12. The method of claim 10, further comprising:
re-projecting the estimated timeline for completion of the objective based at least partially on the historical progress data and at least one task cancellation corresponding to the prompting.

13. A computing system, comprising:
one or more processors; and
a memory coupled to the one or more processors, the memory storing computer-executable instructions that, when executed by the one or more processors, cause the one or more processors to:
store information associated with a plurality of tasks corresponding to a objective, the information including at least:
an indication of actual progress achieved for individual tasks of the plurality of tasks,
an expected progress for the individual tasks, and
recent activity data associated with the individual tasks;
determine, based at least partially on the recent activity data and a difference between the indication of actual progress and the expected progress, at least a first probability that a first task will be timely completed and a second probability that a second task will be timely completed;
based on the first probability being less than a probability threshold, elevating the first task to a risk-group, wherein the risk-group is displayed via a dashboard service of a web site system.

14. The computing system of claim 13, wherein the recent activity data associated with the individual tasks includes at least one of: an increase in a data storage footprint corresponded to the second task; a frequency of data file save events corresponding to the second task; or an indication of file access events corresponding to the second task.

15. The computing system of claim 13, wherein the recent activity data corresponds to a time window that extends into the past by a predetermined length of time.

16. The computing system of claim 13, wherein the computer-executable instructions, when executed by the one or more processors, further cause the one or more processors to receive, for at least some of the individual tasks, impact data corresponding to an importance the at least some of the individual tasks toward the objective.

17. A computer-implemented method, comprising:
under control of one or more processors specifically configured with executable instructions,
receiving information associated with a plurality of tasks corresponding to a objective, the information including at least a plurality of task owners and a plurality of deadlines;
receiving progress updates that indicate actual progress achieved corresponding to individual tasks of the plurality of tasks;
calculating, for the individual tasks of the plurality of tasks, expected progress based on activity commencement dates and the plurality of deadlines;
tracking recent activity associated with the individual tasks of the plurality of tasks; and
determining, for the individual tasks of the plurality of tasks, probabilities of timely completion based at least partially on the progress updates, the expected progress, and the recent activity.

18. The method as recited in claim 17, wherein the tracking the recent activity includes tracking at least one of: an amount of the recent activity; or a type of the recent activity.

19. The computing system of claim 17, further comprising obtaining historical performance data that indicates, for individual task owners, whether the individual task owners have historically completed previous tasks prior to corresponding deadlines.

20. The computing system of claim 13, wherein the determining is further based on the historical performance data.
